(19) United States
(12) Patent Application Publication
(10) Pub. No.: US 2016/0316046 A1
(43) Pub. Date: Oct. 27, 2016

(54) MOBILE PHONE WITH INTEGRATED RETRACTABLE IMAGE CAPTURING DEVICE

(71) Applicant: Jianhui Zheng, Fremont, CA (US)

(72) Inventor: Jianhui Zheng, Fremont, CA (US)

(21) Appl. No.: 15/135,448

(22) Filed: Apr. 21, 2016

Related U.S. Application Data
(60) Provisional application No. 62/150,428, filed on Apr. 21, 2015.

(51) Int. Cl. H04M 1/02

(52) U.S. Cl. CPC H04M 1/0264; H04M 1/0249

(57) ABSTRACT

A mobile phone may include a phone body, a recessed portion and an image capturing unit that is retractable and received in the recessed portion. The phone body and the image capturing unit and the phone body are connected through a connecting rod that has a first movement controlling unit, a second movement controlling unit, and a third movement controlling unit to control the movement of the image capturing unit. The mobile phone may further includes a releasing mechanism, which includes a button and a fastening unit, wherein the fastening unit is configured to secure the image capturing unit in the recessed portion, and the fastening unit is controlled by the button to release the image capturing unit from the recessed portion when the button is pressed.

### CROSS REFERENCE TO RELATED APPLICATIONS

The present invention claims priority under 35 U.S.C. §119 (e) to U.S. Provisional Patent Application Ser. No. 62/150,428, filed on Apr. 21, 2015, the entire contents of which are hereby incorporated by reference.

### FIELD OF THE INVENTION

The present invention relates to an electronic mobile device, and more particularly to a mobile phone with an integrated retractable image capturing device.

### BACKGROUND OF THE INVENTION

Mobile phones are used for a variety of purposes, including keeping in touch with family members, conducting business, and having access to a telephone in the event of an emergency. Some people carry more than one cell phone for different purposes, such as for business and personal use. The ongoing development in digital imaging devices furthermore makes it possible today to equip mobile communication devices with digital cameras at affordable prices, giving rise to new multimedia services. It therefore becomes possible to capture digital photographs or to record digital video clips and, for example, send them to another device by means of the well-known multimedia message system (MMS) or even to enable video conferencing functionality.

The camera typically comprises a small CMOS-based or CCD-based image sensor and associated control electronics. The user can take still and video images in a manner similar to that in which a person uses arty ordinary digital camera. That is, the user aims the camera phone image sensor at a subject and presses one of the buttons on the phone, causing the phone to capture the image of the subject in the form of a digital image file (e.g., JPEG format) in memory. The phone's programming includes functions that not only allow the user to capture images but also to organize and transmit the images through the same wireless telecommunications network through which the user can communicate voice, i.e., telephone calls, using the phone. The network typically includes a server on which the images can be stored, and the network service provider offers users services in connection with the use of the server to save images, upload them to computers via the Internet, and share them with others.

However, current camera phones are not as convenient to use as stand-alone handheld digital cameras and video conferencing cameras. For example, camera phones are generally designed to be easy and comfortable for a user to hold while conducting telephone calls, with little thought given to ease and comfort while taking pictures. More specifically, the phone and camera are not separable so the camera and/or microphone has to be used in a very limited range from the phone itself. Therefore, there remains a need for a new and improved mobile phone with an integrated retractable camera/microphone to overcome the problems presented above.

### SUMMARY OF THE INVENTION

It is an object of the present invention to provide a mobile phone with an integrated image capturing device, in which the image capturing device can be detachably connected to the mobile phone.

It is another object of the present invention to provide a mobile phone with an integrated image capturing device, and the image capturing device can be separated from the mobile phone through a retractable connecting rod.

It is a further object of the present invention to provide a mobile phone with an integrated image capturing device which can take pictures or record voice from the objects away from the phone with the retractable connecting rod.

In one aspect, a mobile phone may include a phone body, a recessed portion and a image capturing unit. The image capturing unit can be pulled out from the recessed portion. The mobile phone may further include a releasing mechanism, which includes a button and a fastening unit, wherein the fastening unit is configured to secure the image capturing unit in the recessed portion, and the fastening unit is controlled by the button to release the image capturing unit from the recessed portion when the button is pressed. It is noted that the image capturing unit can also be used to record videos and equipped with microphones and a second screen. The photo or video that are taken by the image capturing unit can be transmitted to the internet through WIFI or the communication network on the mobilephone.

In another embodiment, the phone body and the image capturing unit are physically connected through a retractable connecting rod, which has a first movement controlling unit, a second movement controlling unit, and a third movement controlling unit, wherein the first movement controlling unit is used to control the left-right movement of the connecting rod, the second movement controlling unit is used to control the front-rear movement of the connecting rod, and the third movement controlling unit allows the connecting rod to rotate for 360 degrees. It is noted that the first movement controlling unit controls the movement of the connecting rod for 180 degrees, as well as the second movement controlling unit. In a further embodiment, the connecting rod can be extended to 3 to 4 feet. When in use, the user can adjust the length of the connecting rod as well as angles using the first, second and third movement controlling units, so the image capturing unit can be used in almost any view angles.

In a further embodiment, the communication between the phone body and the image capturing unit is through a cable and in still a further embodiment, the communication between the phone body and the image capturing unit is wireless, such as WIFI, Bluetooth, etc. When the mobile phone is in use, the phone body and the image capturing unit is usually separated, so the images or videos taken by the image capturing unit can be transmitted to the phone body to save, play and process. Wireless transmission between the phone body and image capturing unit can be used more often because people now take more photos and/or videos for outdoor activities and it may be inconvenient for them to bring a cable while doing outdoor activities.

In still a further embodiment, the image capturing unit may include a camera and a flash light to perform the functions of picture and video taking. The image capturing unit may further include a microphone to record the voice. It is noted that the microphone does not have to be located in the image capturing unit. It can be disposed in other locations of the mobile phone.

### BRIEF DESCRIPTION OF THE DRAWINGS

FIG. 1 illustrates a schematic view of one aspect the mobile phone integrated with retractable image capturing device in the present invention.

FIG. 2 illustrates a lateral schematic view of one aspect the mobile phone integrated with retractable image capturing device in the present invention.

FIG. 3 illustrates a schematic view of another aspect the mobile phone integrated with retractable image capturing device in the present invention.

FIG. 4 illustrates a lateral schematic view of another aspect the mobile phone integrated with retractable image capturing device in the present invention.

FIG. 5 illustrates a schematic view of the axial movement of the image capturing unit on the second screen in the present invention.

FIG. 6 illustrates a schematic view of a further aspect the mobile phone integrated with retractable image capturing device in the present invention.

FIG. 7 illustrates a schematic view of one embodiment of the imaging capturing device having a plurality of cameras surrounding the device.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

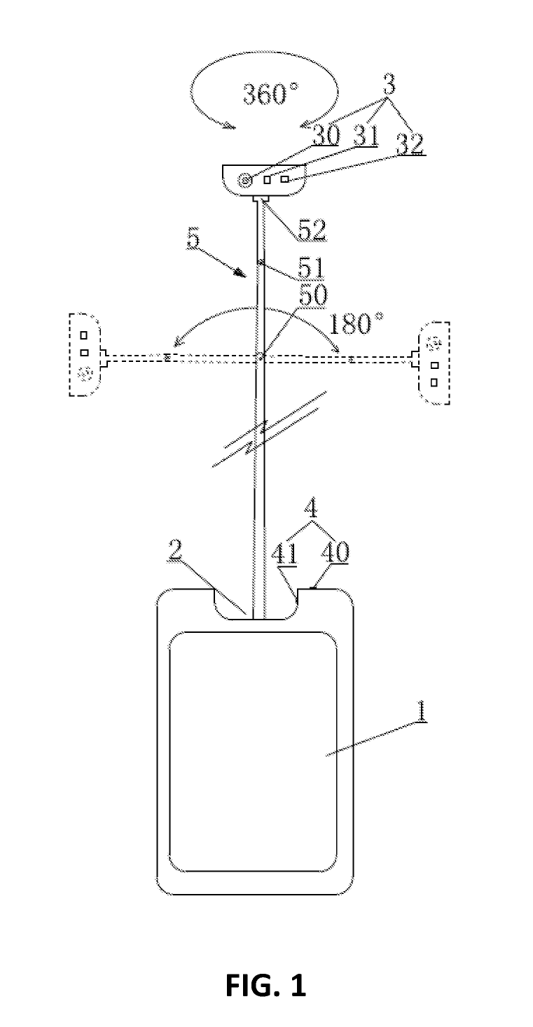

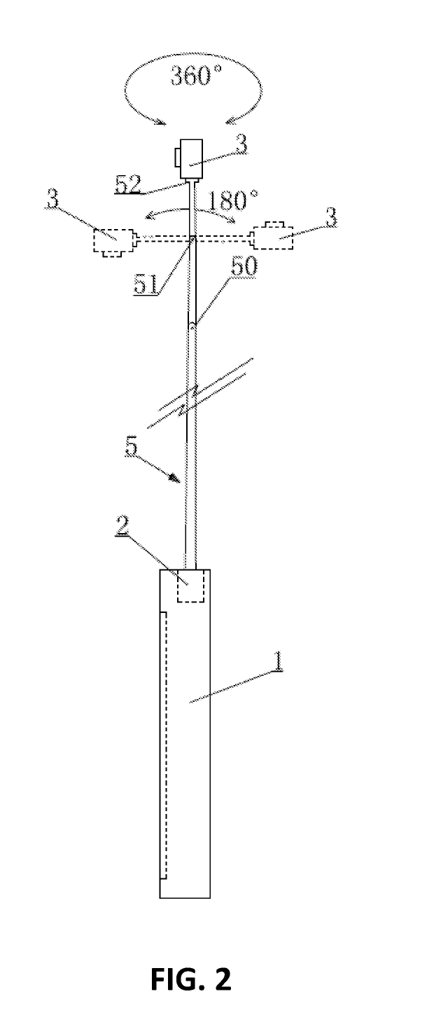

In one aspect, referring to FIGS. 1 and 2, a mobile phone may include a phone body 1, a recessed portion 2 and an image capturing unit 3. The image capturing unit 3 can be pulled out from the recessed portion 2. The mobile phone may further include a releasing mechanism 4, which includes a button 40 and a fastening unit 41, wherein the fastening unit 41 is configured to secure the image capturing unit 3 in the recessed portion 2, and the fastening unit 41 is controlled by the button 40 to release the image capturing unit 3 from the recessed portion 2 when the button 40 is pressed. It is noted that the image capturing unit 3 can also be used to record videos and equipped with microphones and a second screen. The photo or video that are taken by the image capturing unit 3 can be transmitted to the Internet through WIFI or the communication network on the mobile phone.

In another embodiment, the phone body 1 and the image capturing unit 3 are physically connected through a retractable connecting rod 5, which has a first movement controlling unit 50, a second movement controlling unit 51, and a third movement controlling unit 52. As shown in FIGS. 1 to 4, the first movement controlling unit 50 is used to control the left- right movement of the connecting rod 5, the second movement controlling unit 51 is used to control the front-rear movement of the connecting rod 5, and the third movement controlling unit 52 allows the connecting rod 5 to rotate for 360 degrees. It is noted that the first movement controlling unit 50 controls the movement of the connecting rod 5 for 180 degrees (see FIG. 1), as well as the second movement controlling unit 51 (see FIG. 2). In a further embodiment, the connecting rod 5 can be extended to 3 to 4 feet. When in use, the user can adjust the length of the connecting rod 5 as well as angles using the first, second and third movement controlling units (50, 51, 52), so the image capturing unit 3 can be used in almost any view angles.

In a further embodiment, the communication between the phone body 1 and the image capturing unit 3 is through a cable and in still a further embodiment, the communication between the phone body 1 and the image capturing unit 3 is wireless, such as WIFI, Bluetooth, etc. When the mobile phone is in use, the phone body 1 and the image capturing unit 3 is usually separated, so the images or videos taken by the image capturing unit 3 can be transmitted to the phone body I to save, play and process. Wireless transmission between the phone body 1 and image capturing unit 3 can be used more often because people now take more photos and/or videos for outdoor activities and it may be inconvenient for them to bring a cable while doing outdoor activities.

The image capturing unit 3 may include a camera 30 and a flash light 31 to perform the functions of picture and video taking. The image capturing unit 30 may further include a microphone 32 to record the voice. It is noted that the microphone 32 does not have to be located in the image capturing unit 3. It can be disposed in other locations of the mobile phone.

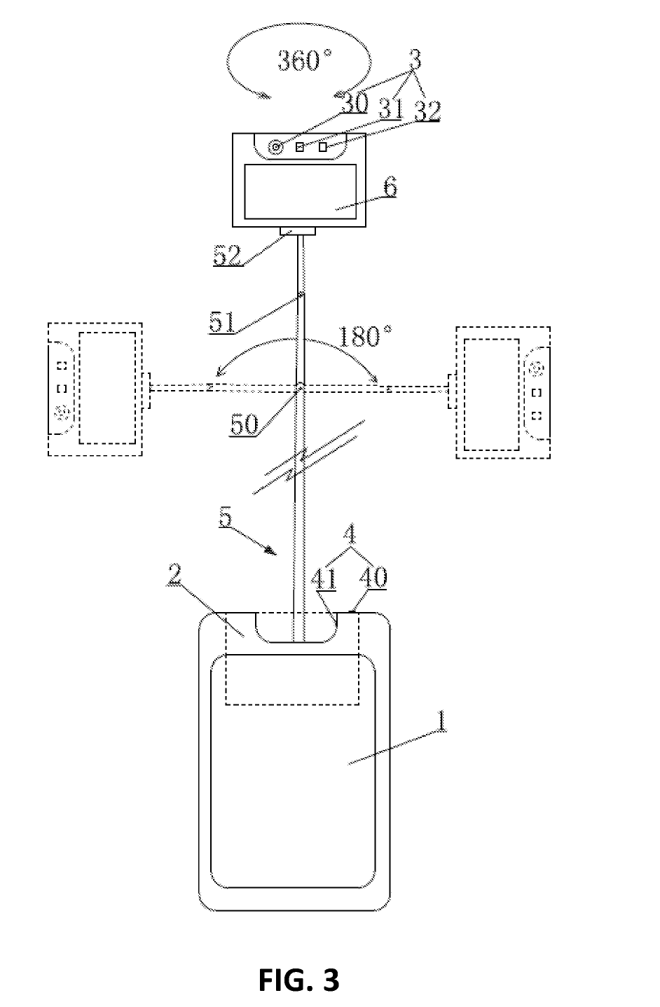

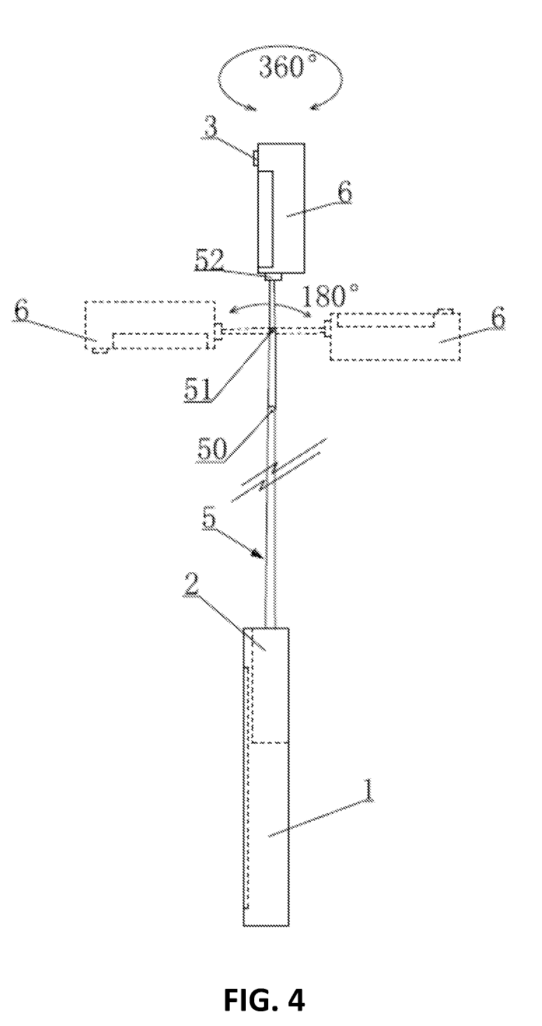

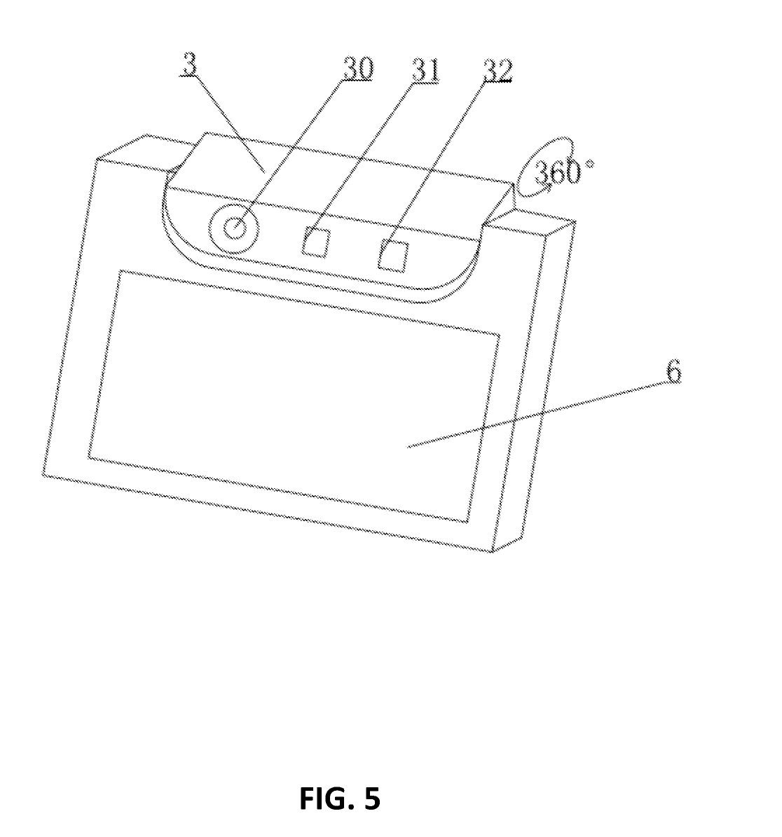

In another aspect, the mobile phone may include a second screen 6 that can also be received in the recessed portion 2 as shown in FIGS. 3 and 4. In one embodiment, the image capturing unit 3 can be integrated together with the second screen 6. Similar to the movement of the image capturing unit 3 discussed above, the movement of the second screen 6 can be adjusted by the first movement controlling unit 50, the second movement controlling unit 51, and the third movement controlling unit 52. It is noted that the image capturing unit 3 can be secured on top of the second screen 6, and the image capturing unit 3 is configured to rotate axially as shown in FIG. 5.

Similar to the image capturing unit 3 discussed above, the second screen 6 can be received in the recessed portion 2 (see the dash line portion in FIG. 3), and the releasing mechanism 4 is configured to secure the second screen 6 in the recessed portion and release it therefrom.

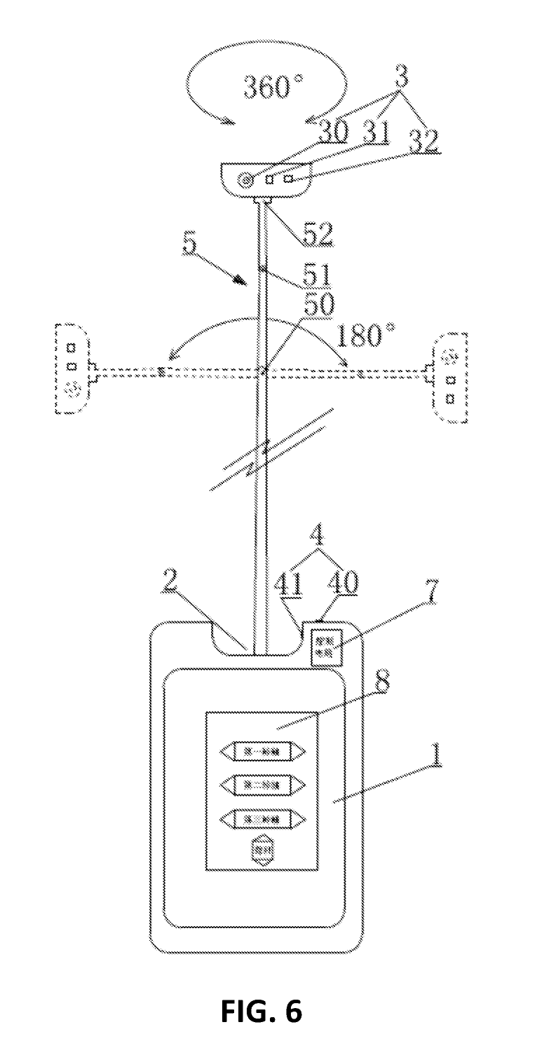

In a further aspect, the connecting rod 5 and the movement controlling units (50, 51, can be electronically controlled. More specifically, the mobile phone has a control unit 7 and an APP 8 installed on the mobile phone to control the movement of the connecting rod 5 as shown in FIG. 6. In one embodiment, the control unit 7 is used to initiate the APP 8. The APP 8 is configured to control the length of the connecting rod 5 and the movement of the first movement controlling unit 50, the second movement controlling unit 51, and the third movement controlling unit 52. The user can also set the rotation or movement angle of the connecting rod 5 through the APP 8. In another embodiment, the APP 8 can be control by voice.

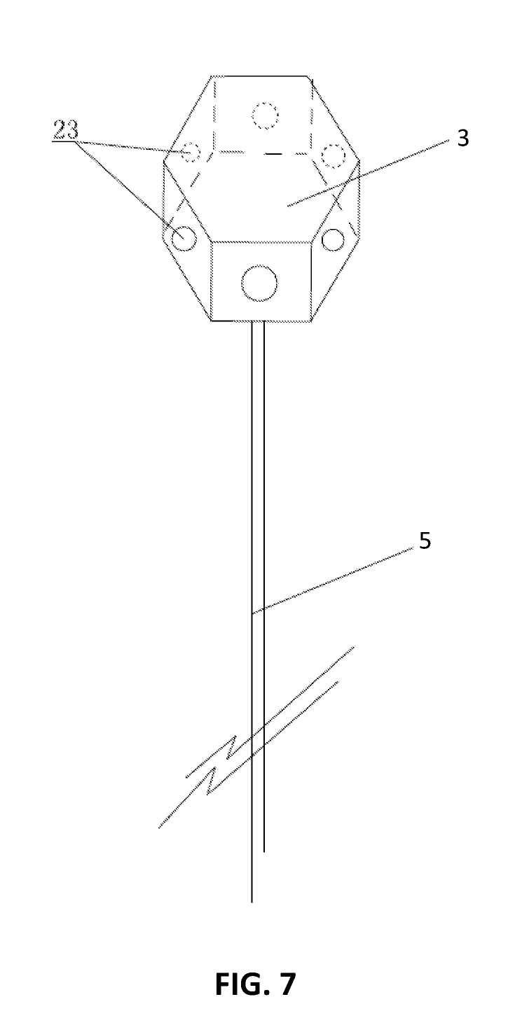

It is noted that the image capturing unit 3 may including a plurality cameras 23 to surround the image capturing unit 3 as shown in FIG. 7, so the user can take a panoramic view without moving the user's body. It is also noted that the size and shape of the recessed portion 2 can be changed according to the size/shape of the image capturing unit 3.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A mobile phone comprising a phone body, a recessed portion and an image capturing unit that is retractable and received in the recessed portion, wherein the phone body and the image capturing unit and the phone body are connected through a connecting rod that has a first movement controlling unit, a second movement controlling unit, and a third movement controlling unit to control the movement of the image capturing unit.

2. The mobile phone of claim 1, wherein the first movement controlling unit controls the movement of the connecting rod for 180 degrees, as well as the second movement controlling unit; and the third movement controlling unit allows the connecting rod to rotate for 360 degrees.

3. The mobile phone of claim 1, wherein the image capturing unit includes at least one camera and flash light.

4. The mobile phone of claim 3, wherein the image capturing unit further includes a microphone.

5. The mobile phone of claim 1, wherein the mobile phone further includes a releasing mechanism, which includes a button and a fastening unit, wherein the fastening unit is configured to secure the image capturing unit in the recessed portion, and the fastening unit is controlled by the button to release the image capturing unit from the recessed portion when the button is pressed.

6. The mobile phone of claim 1, wherein the connecting rod is configured to extend for three to four feet.

7. The mobile phone of claim 1, wherein the length of the connecting rod and the movement controlling units are electronically controlled by an APP on the mobile phone.

8. The mobile phone of claim 1, wherein the image capturing unit includes a second screen.

9. The mobile phone of claim 1, wherein the image capturing unit includes a plurality of cameras surrounding the image capturing unit to enable a user to take a panoramic view without moving the user's body.
